(19) United States
(12) Patent Application Publication
(10) Pub. No.: US 2025/0122343 A1
(43) Pub. Date: Apr. 17, 2025

(54) METHOD FOR PREPARING PRECURSORS

(71) Applicant: QinetiQ Limited, Hampshire (GB)

(72) Inventor: Charles John Michael FOOTER, Hampshire (GB)

(21) Appl. No.: 18/729,283

(22) PCT Filed: Jan. 23, 2023
(86) PCT No.: PCT/EP2023/051526

§ 371 Date: Jul. 16, 2024

(30) Foreign Application Priority Data
Feb. 1, 2022 (GB) 2201257.9

(51) Int. Cl. C08G 77/62

(52) U.S. Cl. CPC C08G 77/62

(57) ABSTRACT

A method for cross-linking an oligosilazane without use of inert gas control can include: mixing the oligosilazane with a solvent; adding a soluble catalyst at a suitable rate to ensure consistent evolution of a gaseous by-product across the surface of the oligosilazane solution; wherein said inert gas control includes measures to replace the atmosphere above the solution with water and/or oxygen depleted gas, including reactions performed within a glove box, using a Schlenk line, or with other purposeful addition of cloaking gases such as nitrogen, argon or dehumidified air. Also provided are polymers prepared by the method, possibly with a low oxygen content, composites prepared from the polymers and uses in aerospace, automotive, oil and gas industries.

### CROSS REFERENCE TO RELATED APPLICATION(S)

This application is a national phase filing under 35 C.F.R. § 371 of and claims priority to PCT Patent Application No. PCT/EP2023/051526, filed on Jan. 23, 2023, and claims the priority benefit under 35 U.S.C. § 119 of British Patent Application No. 2201257.9, filed on Feb. 1, 2022, the contents of each of which are hereby incorporated by reference in their entireties.

The presently disclosed subject matter relates to a method to prepare a polymer for use in ceramics.

In particular the presently disclosed subject matter provides a method of producing a preceramic polymer for Si—C—N ceramics, and products therefrom.

Si—C—N ceramic precursors often require careful control of the atmosphere during synthesis. This is because the polymer precursors comprise a Si—N backbone which is reactive towards water at ambient temperature, and results in hydrolysis to produce siloxanes which, in turn, would produce Si—O ceramics on thermal conversion (pyrolysis).

Standard chemistry methods teach that air- and moisture-sensitive reactions need to be performed under highly controlled conditions such as afforded by a Schlenk line. Prior art methods which specify additional nitrogen blanketing to exclude moisture therefore may require a significant quantity of equipment to control moisture. (e.g. Schlenk lines, glove boxes, solvent drying procedures) etc.

Specific related art teachings in the production of Si—C—N ceramics include U.S. Pat. No. 10,385,234 which discloses a method for the cross-linking of a polysilazane material with a fluoride containing catalyst in tetrahydofuran (THF) which stresses the possible requirement for exclusion of moisture to avoid side reactions. Literature reference O. Flores et al, J. Mat. Chem. A., 2013, 1, 15406 also teaches explicitly that moisture needs to be excluded, even insofar as drying all organic solvents with sodium, and preparation of all or most materials in a glove box. All or most mentions of raw materials include a caveat of using an inert atmosphere. As such, the skilled person is directed to take all or most control measures for moisture exclusion on the understanding that moisture will result in the hydrolysis of the reactive Si—N backbone and results in the production of Si—O ceramics after further processing.

A further problem with related art methods is that existing polymer derived ceramics (PDC) materials cannot be fabricated into large or complex shapes, and current processing methods are not good enough for existing composite manufacture methods or emerging methods, such as additive layer manufacture. What may be required is a method of synthesising a Si—C—N precursor without the expense incurred with moisture-excluding instrumentation and new synthetic methods with improved scalability.

A further problem with existing processes and materials is that they do not allow the manufacture of composite materials, for example, due to poor viscosity that prevents infiltration of fibre composites. As such, development of an easily processable material polymer system that enables the manufacture of ceramic composites would also be highly valuable.

According to the presently disclosed subject matter there is provided an improved method for cross-linking an oligosilazane without use of inert gas control comprising the steps of:
mixing the oligosilazane with a solvent;
adding a soluble catalyst at a suitable rate to ensure consistent evolution of
a gaseous by-product across the surface of the oligosilazane solution;
   wherein said inert gas control comprises measures to replace the atmosphere above the solution with water and/or oxygen depleted gas, including reactions performed within a glove box, using a Schlenk line, or with other purposeful addition of cloaking gases such as nitrogen, argon or dehumidified air.

The catalyst may be a source of fluoride ions. The catalyst may be selected from the group consisting of tetraethylammonium fluoride and tetrabutylammonium fluoride. In certain embodiments, the catalyst is tetrabutylammonium fluoride (TBAF).

The solvent may be tetrahydrofuran. The solvent may additionally be toluene. The solvent may also be 2-methyltetrahydrofuran. The solvent may also be dibutylether. The solvent may be a mix of tetrahydrofuran or toluene in any particular ratio, with or without additional solvents selected from 2-methyltetrahydrofuran and dibutylether. The solvent may additionally be any other solvent known in the art, which dissolves both the oligosilazane, catalyst, and the quenching agent.

The mass ratio of oligomer:solvent may be between 8:1 and 1:8. The mass ratio of oligomer:solvent may more specifically be within the range 8:1 and 1:1, yet more specifically be within the range 8:1 and 3:1, and further within the range 8:1 and 5:1. The mass ratio of oligomer:solvent may alternatively be within the range 1:1 and 1:8, more specifically within the range 1:3 and 1:8, yet more specifically within the range 1:5 and 1:8. The mass ratio of oligomer:solvent may be preferably within the range 1:3 and 3:1. More preferably the mass ratio of oligomer:solvent may be 1:2 and 2:1. Yet more preferably the mass ratio may be 1:1.5 to 1:1. Most preferably the mass ratio is 1:1.

The molar ratio of catalyst to oligomer repeat units may be between 1×10⁻⁴ and 10×10⁻⁴. More preferably, the molar ratio may be between 2×10⁻⁴ and 10×10⁻⁴. Yet more preferably, the molar ratio may be between 2×10⁻⁴ and 7×10⁻⁴. Most preferably the molar ratio may be between 2×10⁻⁴ and 6×10⁻⁴.

The rate of addition of catalyst may be between 10 and 100 (% total catalyst) hour⁻¹.

Preferably the rate of addition may be between 15 and 35 (% total catalyst) hour⁻¹.

The reaction may be performed in a vessel with a height/width dimension ratio of >1.

The vessel may have an inlet aperture width/base dimension of ≤0.5.

The resulting cross-linked polymer may yield a ceramic material without a significant and homogeneous oxygen content on pyrolysis at above 1200° C. in an inert atmosphere.

The catalyst may be added dropwise, and the inhibitor selectively added over the course of the reaction.

In a further aspect the presently disclosed subject matter provides polymers and composites comprising polymer prepared according to a method of the presently disclosed subject matter, and use thereof in aerospace, automotive, oil and gas industries. Preferably the polymers and composites have a low oxygen content such as lower than 10 at % on average across a specimen.

In particular embodiments of the presently disclosed subject matter, the solvent is THF, the catalyst is TBAF, the mass ratio of the oligomer:solvent is between 1:1.5 and 1:1, and the molar ratio of the catalyst:oligomer repeat unit is between 2×10⁻⁴ and 4×10⁻⁴ and the catalyst is added on average at around 17 (% total catalyst) hour⁻¹.

In a particular embodiment, the solvent is THF, the catalyst is TBAF, the mass ratio of oligomer:solvent is 1:1, and the molar ratio of the catalyst:oligomer repeat unit is 3.6×10⁻⁴ and the catalyst is added on average at around 17 (% total catalyst) hour⁻¹.

In other embodiments of the presently disclosed subject matter, the solvent is toluene, the catalyst is TBAF, the mass ratio of the oligomer:solvent is between 1:1.5 and 1:1, and the molar ratio of the catalyst:oligomer repeat unit is between 2×10⁻⁴ and 6×10⁻⁴ and the catalyst is added on average at around 33 (% total catalyst) hour⁻¹.

In a particular embodiment, the solvent is toluene, the catalyst is TBAF, the mass ratio of the oligomer:solvent is 1:1, and the molar ratio of the catalyst:oligomer repeat unit is 2.6×10⁻⁴ and the catalyst is added on average at around 33 (% total catalyst) hour⁻¹.

In a further embodiment, the solvent is toluene, the mass ratio of the oligomer:solvent is 1:1.1, and the molar ratio of the catalyst:oligomer repeat unit is 5.2×10⁻⁴ and the catalyst is added on average at around 33 (% total catalyst) hour⁻¹.

In one embodiment the presently disclosed subject matter provides a method to chemically cross-link a particular polysilazane (Durazane™ 1800, Merck) using a catalyst (tetrabutylammonium fluoride, TBAF) comprising reactive F-ions, which causes a number of reactions resulting in a higher molecular weight polymer material.

In particular, the method of the presently disclosed subject matter is not carried out under dry inert gas. According to an aspect of the presently disclosed subject matter (i.a.) the arrangement is such that sufficient hydrogen gas is produced during the reaction so as to drive the atmosphere above the reaction liquid away, thereby providing in-situ ‘inert’ atmosphere (insofar as moisture is concerned). Also the actual extent of hydrolysis during the method of the presently disclosed subject matter does not seem to produce a particularly high concentration of siloxane (and therefore oxygen) in the final ceramic material produced. A high concentration of oxygen may be defined as an appreciable quantity of the final ceramic comprising an oxide—such as 15 mol %.

As the method of the presently disclosed subject matter is characterised by not including a protection step, unlike related art methods, a significant bonus towards scalability is provided.

In a further aspect, the presently disclosed subject matter further provides a cross-linked material produced from Durazane™ 1800 and TBAF in THF, followed by reaction quenching with Ca(BH₄)₂·2THF to produce CaF₂ and tetrabutylammonium borohydride by-products, followed by filtration and drying under vacuum to produce a ceramic precursor.

The related art does not disclose or teach a cross-linked material prepared by a method comprising the cross-linking of a polysilazane under ambient atmospheric conditions. One of the solutions provided by the presently disclosed subject matter is to rely on the inherent atmosphere generated by the synthesis for shielding and control of the synthesis time to ensure that sufficient H₂ is being evolved to expel H₂O from the reaction vessel atmosphere.

One particular benefit of the presently disclosed subject matter arises from the lack of infrastructural requirement for complex gas supply to the reaction vessel, cleaning or drying procedures for gases and solvents. Modification or additions of any form can be added to the reaction without need for complicated air-sensitive techniques to be employed which are inherently small-scale solutions in synthesis. Hence, the synthesis is yet more flexible and scalable.

Potential applications for an improved PDC precursor according to the presently disclosed subject matter include:
High temperature ceramics for aerospace applications: leading edges, exhaust ducts
High temperature resistance materials-energy materials, automotive, aerospace
Hard materials-Abrasives, bearings, cutting/machining tools
Chemical engineering-catalyst support, food- and biotechnology
Functional materials-electrical engineering, micro/nano-electronics

As such, methods and products of the presently disclosed subject matter have applications in a variety of industries including automotive, aerospace, oil and gas, and the like. The method of the presently disclosed subject matter can also be utilised in combination with other methods as appropriate.

The features of any aspect or embodiment of the presently disclosed subject matter may be used, alone or in any combination, with other aspects and embodiments as appropriate.

### BRIEF DESCRIPTION OF THE FIGURES

The presently disclosed subject matter will now be described in more detail and by way of example only, with reference to the following schematic Figures, in which:

FIG. 1 shows energy dispersive spectroscopy (EDS, elemental analysis) data for a ceramic composite made from the precursor of the method of the presently disclosed subject matter.

FIG. 2 shows a round bottomed flask experimental set up.

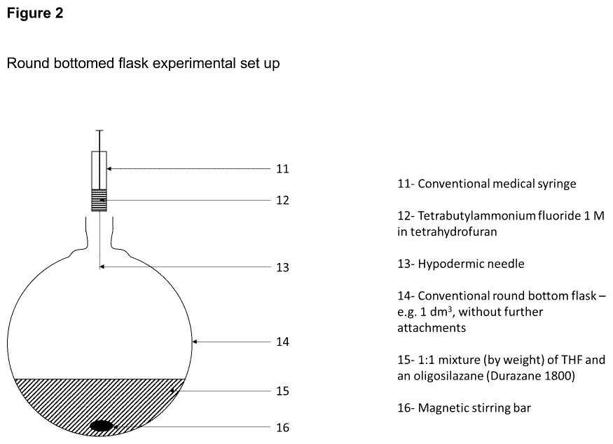

FIG. 3 shows a wide-brimmed container experimental set up.

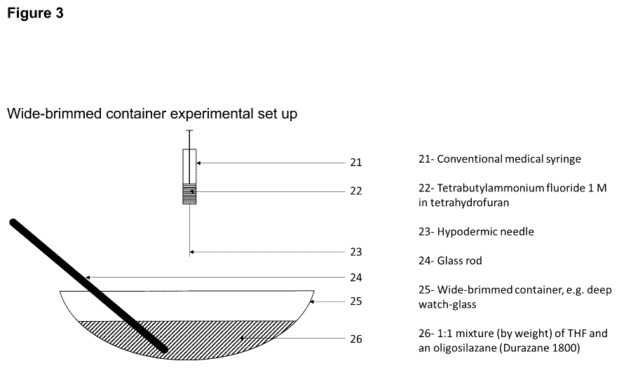

### DETAILED DESCRIPTION

The presently disclosed subject matter will now be described more fully with reference to the accompanying Examples and Figures in which embodiments of the presently disclosed subject matter are shown. This presently disclosed subject matter should not be construed as limited to the embodiments set forth herein.

### Example 1

400 g of an oligosilazane, Durazane™ 1800 (Merck Life Sciences, India), was added to THF (Sigma-Aldrich, Gillingham, UK) in a 1:1 mass ratio under magnetic stirring in a 3 L round bottomed flask, at room temperature. The vessel was 24.3 cm tall, 18.8 cm wide, with high curvature and a 2.5 cm neck opening diameter. No reflux condenser or gas line was added.

After homogenisation, tetrabutylammonium fluoride (TBAF) 1 M in THF (Sigma Aldrich, Gillingham, UK) was added dropwise. The rate of addition was controlled to prevent excessive evolution of H₂ gas, defined as when the entire surface was a covered by a foam, without significant disruption of the surface due to large bubbles. The total quantity of TBAF solution added was 2.3 cm³ over the course of approximately 6 hours, including time during which there was no addition due to the appearance of a full surface foam. Addition of catalyst on top of such a foam would result in over-polymerisation of the thin bubble films, resulting in insoluble scum formation. This corresponded to a final TBAF concentration of 0.00282 M, with an addition rate of 0.00038 mol h⁻¹. The final molar ratio of TBAF:oligosilazane repeat units was 0.000356.

The mixture was left to stir until gas evolution had ended. 0.1 cm³ TBAF solution was added at the end to ensure no further evolution of gas was forthcoming.

Ca(BH₄)₂·2THF (Sigma Aldrich, Gillingham, UK) was added in a 1.5:1 molar ratio with respect to F⁻ as a suspension in THF (approximately 5 cm³). The suspension was stirred for 10 minutes, and was then filtered to remove aggregates and the filtrate collected and used as synthesised in solution in compositing applications.

### Example 2

300 g of an oligosilazane, Durazane™ 1800 was treated with TBAF 1M in THF (1.7 cm³) and Ca(BH₄)₂·2THF as described in Example 1. This corresponded to a final TBAF concentration of 0.00278 M, with an addition rate of 0.00028 mol h⁻¹. The final molar ratio of TBAF:oligosilazane repeat units was 0.000351. Subsequently, the solution was concentrated in a rotary evaporator at 85° C. at pressures between 800 and 300 mBar until a pale yellow oil was obtained. This solidified on cooling to room temperature as a pale glassy solid.

### Example 3

400 g of an oligosilazane, Durazane™ 1800 was treated with TBAF and Ca(BH₄)₂·2THF as described in Example 1. This corresponded to a final TBAF concentration of 0.00282 M, with an addition rate of 0.00038 mol h⁻¹. The final molar ratio of TBAF:oligosilazane repeat units was 0.000351.

The suspension was then filtered to remove aggregates and the filtrate collected. Subsequently, the solution was concentrated in a rotary evaporator at 85° C. at pressures between 850 and 700 mBar for a total of 15 minutes until a pale yellow liquid was obtained. This contained 22 wt % retained THF solvent. This liquid was used as a viscous oil in compositing applications.

### Example 4

30 g of an oligosilazane, Durazane™ 1800 (Merck Life Sciences, India), was added to toluene (Sigma-Aldrich, Gillingham, UK) in a 1:1 mass ratio under magnetic stirring in a 0.4 L round bottomed flask with a height of 13.5 cm, a width of 10 cm and a neck opening diameter of 2.5 cm, at room temperature. No reflux condenser or gas line was added.

After homogenisation, tetrabutylammonium fluoride (TBAF) 1 M in THF (Sigma Aldrich, Gillingham, UK) was added dropwise after 2-fold dilution in toluene. The rate of addition was controlled to prevent excessive evolution of H₂ gas. The total quantity of TBAF solution added was 0.25 cm³. The mixture was left to stir until gas evolution had ended. 0.05 cm³ TBAF solution was added at the end to ensure no further evolution of gas was forthcoming. This corresponded to a final TBAF concentration of 0.00202 M, with an addition rate of 2.08×10⁻⁵ mol h⁻¹. The final molar ratio of TBAF:oligosilazane repeat units was 0.000258.

Ca(BH₄)₂·2THF (Sigma Aldrich, Gillingham, UK) was added in a 1.5:1 molar ratio with respect to F⁻ as a suspension in THF (approximately 5 cm³). The suspension was stirred for 10 minutes, and was then filtered to remove aggregates and the filtrate collected and reduced in a rotary evaporator at 85° C. and 80 mBar. A pale yellow gel was obtained at room temperature.

### Example 5

30 g of an oligosilazane, Durazane™ 1800 (Merck Life Sciences, India), was added to toluene (Sigma-Aldrich, Gillingham, UK) in a 1:1 mass ratio under magnetic stirring in a 1 L round bottomed flask, at room temperature. No reflux condenser or gas line was added.

After homogenisation, tetrabutylammonium fluoride (TBAF) 1 M in THF (Sigma Aldrich, Gillingham, UK) was added dropwise. The rate of addition was controlled to prevent excessive evolution of H₂ gas. The total quantity of TBAF solution added was 0.15 cm³. The mixture was left to stir until gas evolution had ended. 0.05 cm³ TBAF solution was added at the end to ensure no further evolution of gas was forthcoming. This corresponded to a final TBAF concentration of 0.00403 M, with an addition rate of 8.33×10⁻⁵ mol h⁻¹. The final molar ratio of TBAF:oligosilazane repeat units was 0.000516.

Ca(BH₄)₂·2THF (Sigma Aldrich, Gillingham, UK) was added in a 1.5:1 molar ratio with respect to F⁻ as a suspension in THF (approximately 5 cm³). The suspension was stirred for 10 minutes, and was then filtered to remove aggregates and the filtrate collected and reduced in a rotary evaporator at 85° C. and 80 mBar for 3 minutes. The product was collected as a viscous pale liquid at room temperature.

### Example 6

A layer of the oil of Example 3 was extruded and spread evenly on a layer of a plastic release film. A layer of Torayca COR8112 fibre was placed on this layer of oil. A coating was applied using an extruder and rolling device. Further layers of fibre and oil were sequentially applied until a total of 25 fibre plies had been laid up. A further layer of release film was placed on the top of the stack, and the stack placed between two steel plates which were spaced at 4.6 mm with spacers. The lay-up width as produced was 5 mm.

This stack was dried in an oven in ambient conditions at 160° C., and subsequently pyrolysed in Ar(g) at 1280° C. for 1 h. The sample was then tested in flexure according to ASTM C1341, and energy dispersive spectroscopy (Oxford Instruments, Oxford, UK) was performed on the matrix of the subsequently fractured ceramic composite in a scanning electron microscope (SEM).

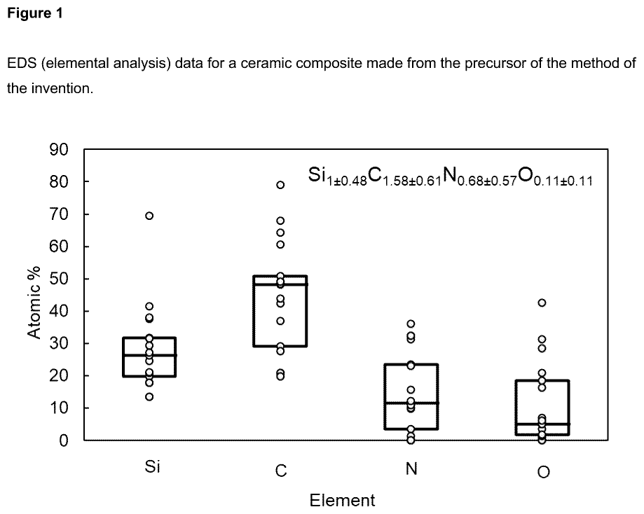

FIG. 1: The atomic percentages from a number of test sites of each of the primary constituents—Si, C, N and O. O was introduced as a contaminant variously during synthesis or pyrolysis. Overlaying the experimental data points are box-and-whisker plots displaying the median and interquartile ranges of the atomic percentage distributions for data collected across the test sites.

From FIG. 1, it is clear that there are, location dependant, large quantities of all or most of the elements are observed. However, statistically speaking, there is a negligible quantity of oxygen across the composite at large. Relative to the abundance of silicon, the matrix has an average stoichiometry of Si_{1±0.48}C_{1.58±0.61}N_{0.68±0.57}O_{0.11±0.11}, indicating that the ceramic is predominantly a Si—C glass with some N, with statistically negligible oxygen content. While a few locations are high in oxygen, this is likely due to localised regions of oxygen enrichment, formed during strength testing or pyrolysis due to insufficiently dry inert gas supply. A wholesale hydrolysis of the precursor would manifest itself as a significant increase in the average oxygen content compared to that observed here.

Thus, it is seen that a method of the presently disclosed subject matter can produce Si—C—N ceramics with minimal oxygen content, without many of the procedural inefficiencies and large-scale inhibiting complications associated with air-sensitive chemical handling techniques.

### Example 7

6 further composite samples were produced following the method described in Example 6. The masses of these composites and the components thereof are shown in Table 1.

TABLE 1
the mass of the composites and the components
thereof before and after the pyrolysis, with
the calculated ceramic yield of the precursor.

| | Green composite | | Pyrolysed | Ceramic |
|---|---|---|---|---|
| | component mass/g | | composite | yield/ |
| Sample | Fibre | Precursor | mass/g | wt % |
| 1 | 13.3 | 23.7 | 21.3 | 0.77 |
| 2 | 13.7 | 24.3 | 22.1 | 0.79 |
| 3 | 13.9 | 24.7 | 21.7 | 0.72 |
| 4 | 13.7 | 22.1 | 19.8 | 0.72 |
| 5 | 14.0 | 22.6 | 20.3 | 0.73 |
| 6 | 14.7 | 23.8 | 20.8 | 0.67 |

The average ceramic yield for the precursor was calculated to be 74±4%. The variation is likely due to lack of consistency in the gas flow and temperature in all or most parts of the heat treatment furnace.

### Comparative Example 1

A mixture of an oligosilazane, Durazane™ 1800 (Merck Life Sciences, India) and THF (Sigma Aldrich, Gillingham, UK) was prepared in a wide-brimmed dish with a width and opening diameter both of 11 cm, and mixed until homogeneous with a glass rod. The total volume was around 10 ml. A few drops of TBAF (1 M in THF) was added to the mixture with vigorous stirring. The fluid evoked significant gas and formed a coagulated, insoluble white crumbly mass.

1. A method for cross-linking an oligosilazane without use of inert gas control comprising:
mixing the oligosilazane with a solvent;
adding a soluble catalyst at a suitable rate to ensure consistent evolution of a gaseous by-product across the surface of the oligosilazane solution;
wherein said inert gas control comprises measures to replace the atmosphere above the solution with at least one selected from the group consisting of water and oxygen depleted gas, including a reaction performed within a glove box, using a Schlenk line, or with other purposeful addition of cloaking gas.

2. The method of claim 1, wherein the catalyst is a source of fluoride ions.

3. The method of claim 2, wherein the catalyst is tetrabutylammonium fluoride.

4. The method of claim 1 wherein the solvent is selected from the group consisting of tetrahydrofuran, toluene, 2-methyltetrahydrofuran, dibutylether, and a mixture thereof.

5. The method of claim 1 wherein the mass ratio of oligomer:solvent is between 8:1 and 1:8.

6. The method of claim 1 wherein the molar ratio of catalyst to oligomer repeat units is between 1×10⁻⁴ and 10×10⁻⁴.

7. The method of claim 1 wherein the rate of addition of catalyst is between 10 and 100 (% total catalyst) hour⁻¹.

8. The method of claim 1 wherein the reaction is performed in a vessel with a height/width dimension ratio of >1.

9. The method of claim 1 wherein the vessel has an inlet aperture width/base dimension of ≤0.5.

10. The method of claim 1 wherein a resulting cross-linked polymer yields a ceramic material without a significant and homogeneous oxygen content on pyrolysis at above 1200° C. in an inert atmosphere.

11. A method according to claim 1 wherein the catalyst is added dropwise, and the inhibitor is selectively added over the course of the reaction.

12. A method according to claim 1 wherein the solvent is selected from the group consisting of tetrahydrofuran, toluene, and a mixture thereof.

13. Polymers prepared by a method according to claim 1, with an oxygen content lower than 10%.

14. Composites prepared using the polymers of claim 13.

15. Use of polymers or composites prepared by claim 14 in aerospace, automotive, oil and gas industries.

16. Use of polymers prepared by claim 13 in aerospace, automotive, oil and gas industries.

17. The method of claim 1, wherein the cloaking gas is at least one selected from the group consisting of nitrogen, argon and dehumidified air.
